(19) United States
(12) Patent Application Publication
(10) Pub. No.: US 2017/0171596 A1
(43) Pub. Date: Jun. 15, 2017

(54) ELECTRONIC DEVICE AND METHOD FOR VIDEO PROGRAM INTERACTION

(71) Applicants: Le Holdings (Beijing) Co., Ltd., Beijing (CN); LE SHI ZHI XIN ELECTRONIC TECHNOLOGY (TIANJIN) LIMITED, Tianjin (CN)

(72) Inventors: Lei SHI, Tianjin (CN); Xue ZHOU, Tianjin (CN)

(21) Appl. No.: 15/250,515

(22) Filed: Aug. 29, 2016

Related U.S. Application Data
(63) Continuation of application No. PCT/CN2016/088719, filed on Jul. 5, 2016.

(30) Foreign Application Priority Data
Dec. 14, 2015 (CN) 201510933345.7

(51) Int. Cl. H04N 21/422; H04N 21/431; H04N 21/84; H04N 21/41; H04N 21/472

(52) U.S. Cl. CPC H04N 21/42204; H04N 21/4126; H04N 21/472; H04N 21/84; H04N 21/4312; H04W 84/12

(57) ABSTRACT

A video program interaction method and an electronic device is disclosed. The video program interaction method includes: requesting, from a video device connected to a mobile terminal, an identifier of a video program being played by the video device; acquiring the identifier of the video program sent by the video device; acquiring first predetermined information of the video program according to the identifier of the video program; and displaying the first predetermined information of the video program. In the embodiment of the present disclosure, after requesting, from the video device, the identifier of the video program being played, the mobile terminal acquires related content of the video program to present the content to the user according to the identifier, such that interactions between the user and the video program being played by the video device via the mobile terminal may be increased, and the user experience is further enhanced.

### CROSS REFERENCE TO RELATED APPLICATIONS

This application is a continuation of International Application No. PCT/CN2016/088719 filed on Jul. 5, 2016, which is based upon and claims priority to Chinese Patent Application No. 2015109333457, filed before Chinese Patent Office on Dec. 14, 2015 and entitled “ELECTRONIC DEVICE AND METHOD FOR VIDEO PROGRAM INTERACTION”, the entire contents of which are incorporated herein by reference.

### TECHNICAL FIELD

The present disclosure relates to the field of video technologies, and more particularly, to a electronic device and method for video program interaction.

### BACKGROUND

With the development of the video technologies, smart televisions are used more frequently. At the same time, use of mobile phones becomes wide. With the popularity of the mobile phones and smart televisions, remote control of the television by using the functions of the mobile phones becomes inevitable. In the urban population of China, almost everyone possesses a smart phone. In addition, the smart phone is portable, but the remote control of the smart television is not portable. It is a usual scenario where the remote control of the smart television cannot be found when a user wants to turn on the smart television or switch a channel. If the smart television is remotely controlled by a smart phone, the problem is solved.

According to the related art, a mobile phone may serve as the remote control of the smart television. For example, when an infrared transmitter to support an infrared remote control function is built-in the smart phone, a universal remote control application is directly downloaded and installed on the smart phone. After the application is launched, the television matches with the smart phone. Upon successful matching, the smart phone may be used as the remote control of the smart television. Or, when the smart phone is not provided with the infrared transmitter, and does not support the infrared remote control function, an externally universal remote control of the smart phone may be used, and is connected to the smart phone. Subsequently, the universal remote control application is downloaded from the smart phone and installed on the smart phone.

The disclosure is started and matched with the smart television, and upon successful matching, the smart phone may be used as the remote control.

In the related art, the remote control function of the smart phone to the smart television may be implemented via wireless networks. The mainstream smart television at the market also has applications suitable for wireless remote control, such as applications supporting Apple's iOS system and applications supporting the Android system. Nevertheless, such application needs to match with the smart television in the corresponding brand for the usage.

Using the smart phone to perform remote control of the smart television may be implemented when all related devices operate in the same wireless environment. At present, many families establish WiFi networks at their homes, and the smart phone and the smart television have a networked environment. The smart phone is capable of serving as the remote control of the smart television in a scenario where the smart phone supports the downloaded software and the television is a new-generation smart television which is capable of directly accessing the WIFI.

During the implementation of the present disclosure, the inventors have found that the related art has at least the following problem: a mobile phone serving as the remote control only implements a control function of the remote control, and has no two-way interaction with the smart television; specifically, the remote control function of the smart television is implemented only by using the mobile phone, and the mobile phone cannot receive signals from the smart television, and cannot perform interactions according to the video program being played by the smart television.

### SUMMARY

The present disclosure provides a electronic device and method for video program interaction, such that interactions may be performed with a video program being played by a video device via a mobile terminal.

Embodiments of the present disclosure provide a video program interaction method. The method includes: requesting, from a video device connected to a mobile terminal, an identifier of a video program being played by the video device; acquiring the identifier of the video program sent by the video device; acquiring first predetermined information of the video program according to the identifier of the video program; and displaying the first predetermined information of the video program.

Embodiments of the present disclosure further provide a non-volatile computer storage medium storing computer executable instructions, wherein the computer executable instructions may be used to perform any one video program interaction method as defined in the present disclosure.

Embodiments of the present disclosure further provide an electronic device. The electronic device includes: at least one processor and a memory; wherein the memory stores instructions executable by the at least one processor, wherein the instructions, when being executed by the at least one processor, causes the at least one processor to perform any one of video program interaction method as defined in the present disclosure.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flowchart illustrating a video program interaction method according to some embodiments of the present disclosure;

FIG. 2 is a flowchart illustrating a video program interaction method according to some embodiments of the present disclosure;

FIG. 3 is a flowchart illustrating a video program interaction method according to some embodiments of the present disclosure;

FIG. 4 is a flowchart illustrating a video program interaction method according to some embodiments of the present disclosure;

FIG. 5 is a flowchart illustrating a video program interaction method according to some embodiments of the present disclosure; and

FIG. 6 is a schematic structural diagram illustrating an electronic device for video program interaction according to some embodiments of the present disclosure;

FIG. 7 is a schematic structural diagram illustrating an electronic device for video program interaction according to some embodiments of the present disclosure;

FIG. 8 is a schematic structural diagram illustrating an electronic device for video program interaction according to some embodiments of the present disclosure;

FIG. 9 is a schematic structural diagram illustrating an electronic device for video program interaction according to some embodiments of the present disclosure;

FIG. 10 is a schematic structural diagram illustrating an electronic device for video program interaction according to some embodiments of the present disclosure; and

FIG. 11 is a schematic structural diagram illustrating hardware of an electronic device for performing the video program interaction method according to some embodiments of the present disclosure.

### DETAILED DESCRIPTION

To make the objectives, technical solutions and advantages of the present disclosure clearer, the technical solutions in the embodiments of the present disclosure are described clearly and completely with reference to the accompanying drawings in the embodiments of the present disclosure. Apparently, the described embodiments are merely some of rather than all of the embodiments of the present disclosure. Based on the embodiments of the present disclosure, all other embodiments derived by persons of ordinary skill in the art without any creative efforts shall fall within the protection scope of the present disclosure.

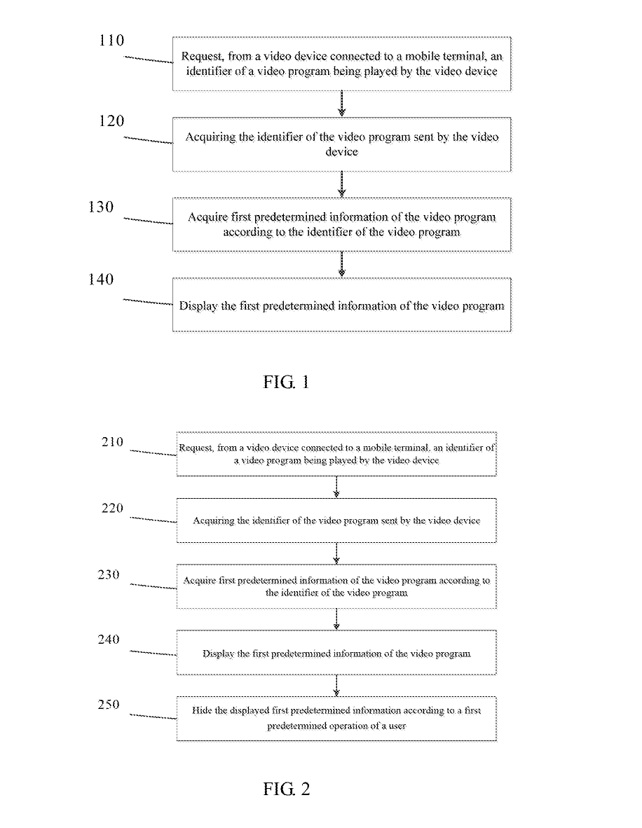

FIG. 1 is a flowchart illustrating a video program interaction method according to some embodiments of the present disclosure. Referring to FIG. 1, the video program interaction method according to the embodiment of the present disclosure includes the following steps.

Step 110: An identifier of a video program being played by a video device is requested from the video device connected to a mobile terminal.

In the embodiment of the present disclosure, the mobile terminal and the video device are configured with an application capable of performing remote control. For example, the application capable of performing remote control of the video device via a wireless local area networks (WLAN) is installed on the mobile terminal, and the application capable of receiving remote control information sent by the mobile terminal via the WLAN may be also installed on the video device. Specifically, different application may be installed according to different types of video devices and different types of mobile terminals.

The mobile terminal sends a request via the WLAN. Upon receiving the request, the video device running in the WLAN returns a response, and the mobile terminal establishes a connection with the video device according to the returned response. Specifically, when the video device stays in a running state, for example, when the video device is playing the video program, the mobile terminal establishes the connection with the video device via the WLAN. It may be understood that when the video device is disabled, the mobile terminal may not establish the connection with the video device. In this case, the video device may not receive signals from the mobile terminal, and the mobile terminal may not be used as a remote control of the video device.

The video program played by the video device has a corresponding identifier. For example, the identifier of the video program may be determined by presetting identifier for each program, or may be determined according to the source of the video program.

In this step, after the connection is established between the mobile terminal and the video device, the mobile terminal requests, from the video device connected to the mobile terminal, the identifier of the video program being played by the video device. If multiple mobile terminals or multiple video devices are present in the WLAN, the mobile terminal sends the request to the video device which establishes the connection with the mobile terminal, and requests the identifier of the video program being played by the video device.

Step 120: The identifier of the video program sent by the video device is acquired.

It may be understood that, upon receiving the request from the mobile terminal, the video device acquires the identifier of the video program being played by the video device. For example, when the video device stores the identifier of the video program, the video device may acquire the identifier of the video program from a location where the identifier is stored; and when the video device stores no identifier of the video program, the video device may send a request to a device that stores the identifier to acquire the identifier of the video program. How to acquire the identifier of the video program by the video device is not limited in the embodiment of the present disclosure.

Upon receiving the request from the mobile terminal, the video device sends the identifier of the video program being played by the video device to the mobile terminal. Correspondingly, in this step, the mobile terminal acquires the identifier of the video program being played by the video device and sent by the video device.

Step 130: First predetermined information of the video program is acquired according to the identifier of the video program.

Upon knowing the identifier of the video program being played by the video device that is remotely controlled by the mobile terminal, the mobile terminal may acquire the first predetermined information of the video program according to the identifier of the video program. It may be understood that the identifier of the video program and the first predetermined information of the video program are in a corresponding relationship. First information may be preset information related to the video program. When the mobile terminal acquires information of the video program according to the identifier of the video program, the first predetermined information may be a brief of the video program, or actor/actress/star information of the video program, or a broadcasting radio station and broadcasting time, or the number of peoples who are watching the video program at the same time, or the like. The first predetermined information may be any preset information related to the video program, which is not limited in the embodiment of the present disclosure. For ease of description, the details are not given herein any further.

In this step, the mobile terminal acquires the first predetermined information of the video program according to the identifier of the video program. Specifically, the mobile terminal may send the identifier to a server, or to any one device that pre-stores the first predetermined information of the video program, to acquire the first predetermined information of the video program corresponding to the identifier. After the device that stores the first predetermined information sends the first predetermined information to the mobile terminal, the mobile terminal may acquire the first predetermined information of the video program.

Step 140: The first predetermined information of the video program is displayed.

After the mobile terminal acquires the first predetermined information of the video program, the first predetermined information may be displayed via a displaying module. Specifically, for example, the acquired first predetermined information may be fully displayed on a display screen of the mobile terminal, or may be partially displayed, and specific content to be displayed may be subsequently determined when a user performs operations. For example, if the acquired first predetermined information includes an actor/actress of the video program, the displayed content may be only the actor/actress, the specific actors/actresses may be displayed when the user needs to check, or the displayed content may be directly all the specific actors/actresses of the program. These may be determined via presetting. An objective is to enable the user to know more information of the video being played via the mobile device.

In the embodiment of the present disclosure, upon requesting, from the video device, the identifier of the video program being played, the mobile terminal acquires related content of the video program to present the content to the user according to the identifier, such that interactions between the user and the video program being played by the video device via the mobile terminal may be increased, and the user experience is further enhanced.

FIG. 2 is a flowchart illustrating a video program interaction method according to some embodiments of the present disclosure. Referring to FIG. 2, the video program interaction method according to the embodiment of the present disclosure includes the following steps.

Step 210: An identifier of a video program being played by a video device is requested from the video device connected to a mobile terminal.

This step that an identifier of a video program being played by a video device is requested from the video device connected to a mobile terminal may refer to step 110 in the embodiment corresponding to FIG. 1.

Step 220: The identifier of the video program sent by the video device is acquired.

This step that an identifier of a video program being played by a video device is requested from the video device connected to a mobile terminal may refer to step 120 in the embodiment corresponding to FIG. 1.

Step 230: First predetermined information of the video program is acquired according to the identifier of the video program.

This step that an identifier of a video program being played by a video device is requested from the video device connected to a mobile terminal may refer to step 130 in the embodiment corresponding to FIG. 1.

Step 240: The first predetermined information of the video program is displayed.

This step that an identifier of a video program being played by a video device is requested from the video device connected to a mobile terminal may refer to step 140 in the embodiment corresponding to FIG. 1.

Step 250: The displayed first predetermined information is hidden according to a first predetermined operation of a user.

The first predetermined information of the video program displayed on the mobile terminal may be hidden by a user via the first predetermined operation. For example, the predetermined operation may be an operation via a key of the mobile terminal, or may be an operation via a key displayed on a screen of the mobile terminal, or may be an operation via a gesture. For example, the first predetermined operation may be a gesture of swiping upward or downward at a location that displays the first predetermined information on the mobile terminal. The displayed first predetermined information is hidden according to the gesture. For example, when the first predetermined information is displayed on the top-most part of the screen and the user swipes upward, the first predetermined information may be hidden.

In the embodiment of the present disclosure, after the first predetermined information is displayed, the displayed information may be hidden according to the operation of the user. As such, the display screen of the mobile terminal may display other information, such that the user is capable of performing other operations, thereby further improving flexibility of interactions, and enhancing user experience.

Specifically, the video program interaction method further includes displaying the hidden information according to a second predetermined operation of the user. For example, following the above embodiment, after the user hides the first predetermined information displayed on the top-most part of the mobile terminal by using an upward swipe gesture, the hidden information may be displayed again according to the second predetermined operation. For example, when the second predetermined operation is a downward swipe operation, the hidden information may be displayed again by using the downward swipe gesture of the user from the top-most part of the mobile terminal.

In this embodiment, interactions between the user and the video program being played by the video device via the mobile terminal may be specifically increased, thereby further enhancing the user experience.

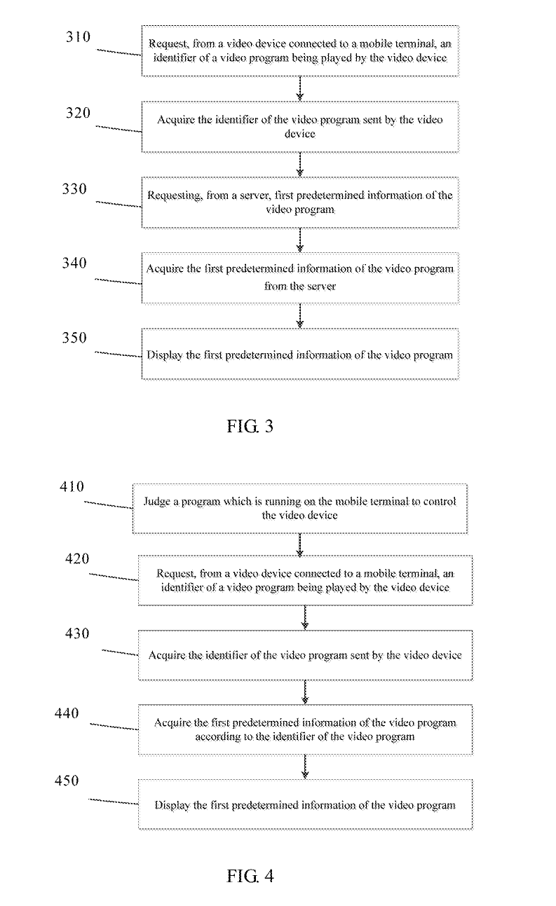

FIG. 3 is a flowchart illustrating a video program interaction method according to some embodiments of the present disclosure. Referring to FIG. 3, the video program interaction method according to the embodiment of the present disclosure includes the following steps.

Step 310: An identifier of a video program being played by a video device is requested from the video device connected to a mobile terminal.

This step that an identifier of a video program being played by a video device is requested from the video device connected to a mobile terminal may refer to step 110 in the embodiment corresponding to FIG. 1.

Step 320: The identifier of the video program sent by the video device is acquired.

This step that an identifier of a video program being played by a video device is requested from the video device connected to a mobile terminal may refer to step 120 in the embodiment corresponding to FIG. 1.

Step 330: First predetermined information of the video program is request from a server.

In this step, the mobile terminal may send information to the server, and the information carries the identifier of the video program. As such, the mobile terminal requests from the server the first predetermined information of the video program. It may be understood that the server stores the first predetermined information of the video program, or the server may acquire the first predetermined information of the video program.

Step 340: The first predetermined information of the video program is acquired from the server.

The mobile terminal acquires the first predetermined information of the video program sent by the server. When receiving the information, the mobile terminal may judge where the information comes from according to the information source, and if the information comes from the server, the mobile terminal may further check the information, and acquire the first predetermined information of the video program from the server.

Step 350: The first predetermined information of the video program is displayed.

This step that an identifier of a video program being played by a video device is requested from the video device connected to a mobile terminal may refer to step 140 in the embodiment corresponding to FIG. 1.

In the embodiment of the present disclosure, the first predetermined information of the video program is requested from the server, and the first predetermined information of the video program is acquired from the server, such that more program information which is more accurate may be further acquired, and interactions between the user and the video program played by the video device may be deepened via the mobile terminal.

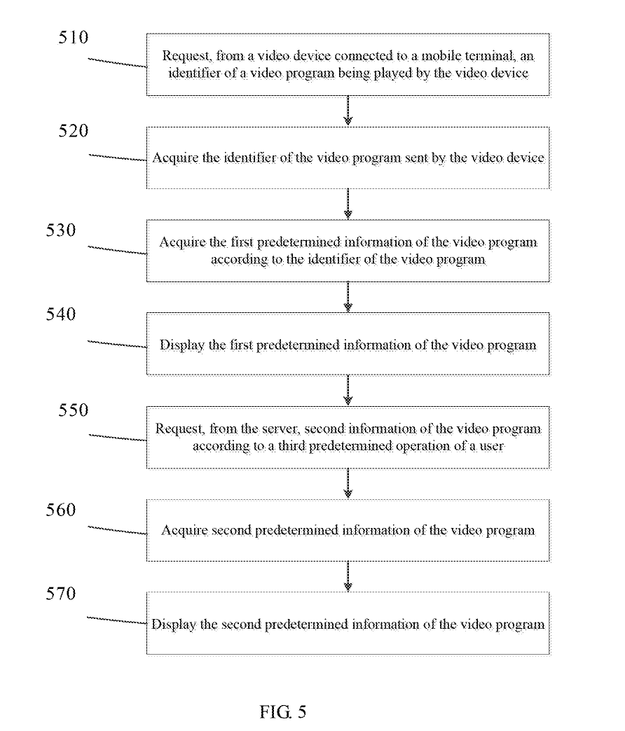

FIG. 4 is a flowchart illustrating a video program interaction method according to some embodiments of the present disclosure. As illustrated in FIG. 4, the video program interaction method according to the embodiment of the present disclosure may include the following steps.

Step 410: A program which is running on the mobile terminal to control the video device is judged.

In this step, the mobile device judges a program which is running on the mobile terminal to control the video device. Specifically, the mobile device needs to judge whether a user watches the video program, and whether the user performs interaction with the video program played via the mobile terminal and video device.

Step 420: An identifier of a video program being played by the video device is requested from a video device connected to a mobile terminal.

This step that an identifier of a video program being played by a video device is requested from the video device connected to a mobile terminal may refer to step 140 in the embodiment corresponding to FIG. 1.

Step 430: The identifier of the video program sent by the video device is acquired.

This step that an identifier of a video program being played by a video device is requested from the video device connected to a mobile terminal may refer to step 120 in the embodiment corresponding to FIG. 1.

Step 440: The first predetermined information of the video program is acquired according to the identifier of the video program.

This step that an identifier of a video program being played by a video device is requested from the video device connected to a mobile terminal may refer to step 130 in the embodiment corresponding to FIG. 1.

Step 450: The first predetermined information of the video program is displayed.

This step that an identifier of a video program being played by a video device is requested from the video device connected to a mobile terminal may refer to step 140 in the embodiment corresponding to FIG. 1.

In the embodiment of the present disclosure, it is judged that whether the mobile terminal is controlling the program of the video device, if the mobile terminal is controlling the program of the video device, the user is enabled to participate in, via the mobile terminal, interactions with the video program being played by the video device, such that an opportunity that the user needs to perform interaction may be accurately seized, the interaction is more intelligent and humanization, and user experience is improved.

FIG. 5 is a flowchart illustrating a video program interaction method according to some embodiments of the present disclosure. As illustrated in FIG. 5, the video program interaction method according to the embodiment of the present disclosure may include the following steps.

Step 510: An identifier of a video program being played by the video device is requested from a video device connected to a mobile terminal.

This step that an identifier of a video program being played by a video device is requested from the video device connected to a mobile terminal may refer to step 110 in the embodiment corresponding to FIG. 1.

Step 520: The identifier of the video program sent by the video device is acquired.

This step that an identifier of a video program being played by a video device is requested from the video device connected to a mobile terminal may refer to step 120 in the embodiment corresponding to FIG. 1.

Step 530: The first predetermined information of the video program is acquired according to the identifier of the video program.

This step that an identifier of a video program being played by a video device is requested from the video device connected to a mobile terminal may refer to step 130 in the embodiment corresponding to FIG. 1.

Step 540: The first predetermined information of the video program is displayed.

This step that an identifier of a video program being played by a video device is requested from the video device connected to a mobile terminal may refer to step 140 in the embodiment corresponding to FIG. 1.

Step 550: Second information of the video program is requested from a server according to a third predetermined operation of a user.

In the above steps, since the user has known the first predetermined information of the video program, in this step, the user desires to further know the second information of the video program according to the first predetermined information of the video program that has been known. For example, following the above embodiment, assume that the first predetermined information of the video program displayed in the above step is actor/actress information, then in this step, the mobile terminal may acquire further detailed information of the actor/actress according to the third predetermined operation. Alternatively, if the first predetermined information is other information, the user may request, from the server, other second information of the video program according to the third predetermined operation. It may be understood that the third predetermined operation may be a key operation, a gesture operation, or a screen touch operation, which is not limited in the embodiment of the present disclosure. The second information may be also any predetermined information. For example, details of the actor/actress may be such personal information as age, height or the like of the actor/actress, or may be awards information, resume or the like of the actor/actress, which are not limited in the embodiment of the present disclosure.

Step 560: Second predetermined information of the video program is acquired.

In this step, the mobile terminal acquires the second predetermined information of the video program according to information returned by the server.

Step 570: The second predetermined information of the video program is displayed.

In this step, the mobile terminal displays the second predetermined information of the video program acquired in step 560.

In the embodiment of the present disclosure, upon displaying the first predetermined information of the video program, the mobile terminal acquires and displays the second predetermined information of the video program according to the operation of the user, such that the user may get more and deeper knowledge of the video program, interactions between the user and the video program played by the video device may be further deepened via the mobile terminal, and the user experience is further enhanced.

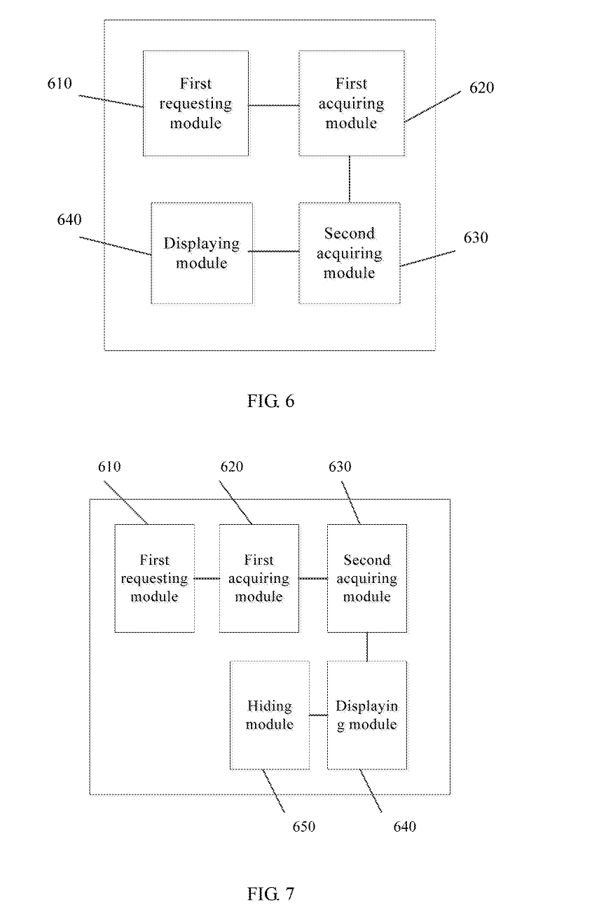

FIG. 6 is a schematic structural diagram illustrating an electronic device for video program interaction according to some embodiments of the present disclosure. Referring to FIG. 6, the electronic device for video program interaction according to the embodiment of the present disclosure includes: a first requesting module 610, a first acquiring module 620, a second acquiring module 630, and a displaying module 640.

The first requesting module 610 is configured to request, from a video device connected to a mobile terminal, an identifier of a video program being played by the video device.

The mobile terminal sends a request via the WLAN. Upon receiving the request, the video device running in the WLAN returns a response, and the mobile terminal establishes a connection with the video device according to the returned response. Specifically, when the video device stays in a running state, for example, the video device is playing the video program, the mobile terminal establishes the connection with the video device via the WLAN. It may be understood that when the video device is disabled, the mobile terminal may not establish the connection with the video device; in this case, the video device may not receive signals from the mobile terminal, and the mobile terminal may not be used as a remote control of the video device. The video program played by the video device has a corresponding identifier. For example, the identifier of the video program may be determined by presetting identifier for each program, or may be determined according to the source of the video program.

After the first requesting module 610 establishes the connection between the mobile terminal and the video device, the mobile terminal requests, from the video device connected to the mobile terminal, the identifier of the video program being played by the video device. If multiple mobile terminals or multiple video devices are present in the WLAN, the mobile terminal sends the request to the video device which establishes the connection with the mobile terminal, and requests the identifier of the video program being played by the video device.

The first acquiring module 620 is configured to acquire the identifier of the video program sent by the video device.

Upon receiving the request from the mobile terminal, the video device sends the identifier of the video program being played by the video device to the mobile terminal. Correspondingly, the first acquiring module 620 acquires the identifier of the video program, being played by the video device, and sent by the video device.

The second acquiring module 630 is configured to acquire first predetermined information of the video program according to the identifier of the video program.

The second acquiring module 630 of the mobile terminal acquires the first predetermined information of the video program according to the identifier of the video program. Specifically, the mobile terminal may send the identifier to a server, or to any one device that pre-stores the first predetermined information of the video program, to acquire the first predetermined information of the video program corresponding to the identifier. After the device that stores the first predetermined information sends the first predetermined information to the mobile terminal, the second acquiring module 630 of the mobile terminal acquires the first predetermined information of the video program.

The displaying module 640 is configured to display the first predetermined information of the video program. After the mobile terminal acquires the first predetermined information of the video program, the displaying module 640 displays the first predetermined information. Specifically, for example, the acquired first predetermined information may be fully displayed on a display screen of the mobile terminal, or may be partially displayed, and specific content to be displayed may be subsequently determined when a user performs operations. For example, if the acquired first predetermined information includes an actor/actress of the video program, the displayed content may be only the actor/actress, the specific actors/actresses may be displayed when the user needs to check, or the display content may be directly all the specific actors/actresses in the program. These may be determined via presetting. An objective is to enable the user to know more video information being played via the mobile device.

In the embodiment of the present disclosure, upon requesting, from the video device, the identifier of the video program being played, the mobile terminal acquires related content of the video program to present the content to the user according to the identifier, such that interactions between the user and the video program being played by the video device via the mobile terminal may be increased, and the user experience is further enhanced.

FIG. 7 is a schematic structural diagram illustrating an electronic device for video program interaction according to some embodiments of the present disclosure. Referring to FIG. 7, the electronic device for video program interaction according to the embodiment of the present disclosure includes: a first requesting module 610, a first acquiring module 620, a second acquiring module 630, and a displaying module 640, wherein the specific operations of these modules may refer to specific implementation methods of the modules corresponding to FIG. 6. The electronic device for video program interaction may further include a hiding module 650. The hiding module 650 is configured to hide the displayed first predetermined information according to a first predetermined operation of a user.

The first predetermined information of the video program displayed on the mobile terminal may be hidden by a user via the first predetermined operation hiding module 650. For example, the predetermined operation may be an operation via a hard button of the mobile terminal, or may be an operation via a key displayed on a screen of the mobile terminal, or may be an operation via a gesture. For example, the first predetermined operation may be a gesture for swiping upward or downward at a location that displays the first predetermined information on the mobile terminal. The displayed first predetermined information is hidden according to the gesture. For example, when the first predetermined information is displayed on the top-most part of the screen and the user swipes upward, the first predetermined information may be hidden.

In the embodiment of the present disclosure, after the first predetermined information is displayed, the displayed information may be hidden according to the operation of the user. As such, the display screen of the mobile terminal may display other information, such that the user may perform other operations, thereby further improving flexibility of interaction, and enhancing user experience.

Specifically, the displaying module is further configured to display the hidden information according to a second predetermined operation of the user. For example, following the above embodiment, after the user hides the first predetermined information displayed on the top-most part of the mobile terminal by using an upward swipe operation, the displaying module may display the hidden information again according to the second predetermined operation. For example, when the second predetermined operation is a downward swipe operation, the displaying module may display the hidden information again by using the downward swipe gesture of the user from the top-most part of the mobile terminal.

In this embodiment, interactions between the user and the video program being played by the video device via the mobile terminal may be specifically increased, to further enhance the user experience.

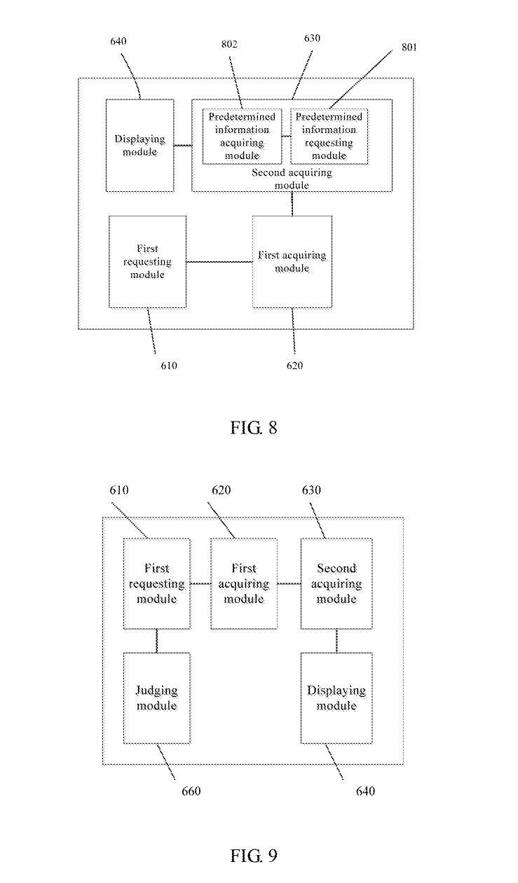

FIG. 8 is a schematic structural diagram illustrating an electronic device for video program interaction according to some embodiments of the present disclosure. Referring to FIG. 8, the electronic device for video program interaction according to the embodiment of the present disclosure includes: a first requesting module 610, a first acquiring module 620, a second acquiring module 630, and a displaying module 640, wherein the specific operations of these modules may refer to specific implementation methods of the modules corresponding to FIG. 6. The second acquiring module 630 includes: a predetermined information requesting module 801 and a predetermined information acquiring module 802.

The predetermined information requesting module 801 is configured to request, from a server, the first predetermined information of the video program.

The predetermined information requesting module 801 of the mobile terminal may send information to the server, and the information carries the identifier of the video program. As such, the mobile terminal requests from the server the first predetermined information of the video program. It may be understood that the server stores the first predetermined information of the video program, or the server may acquire the first predetermined information of the video program.

The predetermined information acquiring module 802 is configured to acquire, from the server, the first predetermined information of the video program.

The predetermined information acquiring module 802 of the mobile terminal acquires the first predetermined information of the video program sent by the server. When receiving the information, the mobile terminal may judge where the information comes from according to the information source, and if the information comes from the server, the mobile terminal may further check information, and acquire the first predetermined information of the video program from the server.

In the embodiment of the present disclosure, the first predetermined information of the video program is requested from the server, and the first predetermined information of the video program is acquired from the server, such that more program information which is more accurate may be further acquired, and interactions between the user and the video program being played by the video device via the mobile terminal may be deepened.

FIG. 9 is a schematic structural diagram illustrating an electronic device for video program interaction according to some embodiments of the present disclosure. Referring to FIG. 9, the electronic device for video program interaction according to the embodiment of the present disclosure includes: a first requesting module 610, a first acquiring module 620, a second acquiring module 630, and a displaying module 640, wherein the specific operations of these modules may refer to specific implementation methods of the modules corresponding to FIG. 6. The electronic device for video program interaction may further include a judging module 660.

The judging module 660 is configured to judge a program which is running by a mobile terminal to control the video device.

The judging module 660 of the mobile device judges a program which is running on the mobile terminal to control the video device. Specifically, the mobile terminal needs to judge whether a user watches the video program, and whether the user performs interaction with the video program played via the mobile terminal and video device.

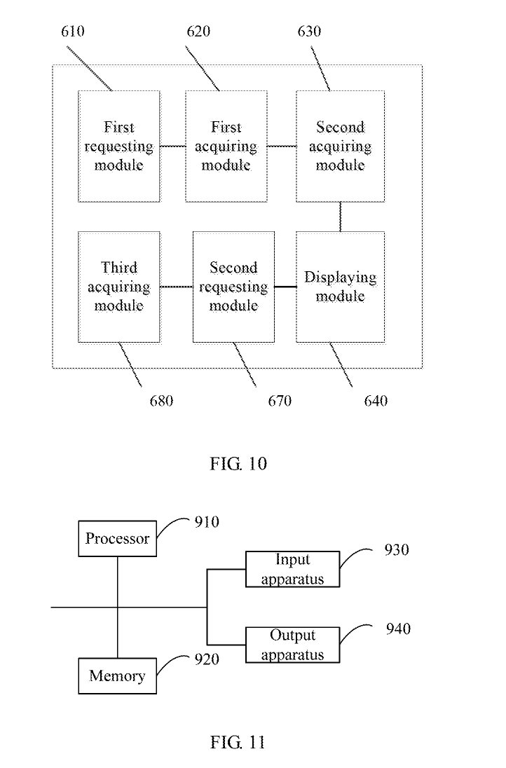

FIG. 10 is a schematic structural diagram illustrating an electronic device for video program interaction according to some embodiments of the present disclosure. Referring to FIG. 10, the electronic device for video program interaction according to the embodiment of the present disclosure includes: a first requesting module 610, a first acquiring module 620, a second acquiring module 630, and a displaying module 640, wherein the specific operations of these modules may refer to specific implementation methods of the modules corresponding to FIG. 6. The electronic device for video program interaction may further include: a second requesting module 670, a third acquiring module 680 and a displaying module.

The second requesting module 670 is configured to request, from the server, second information of the video program according to a third predetermined operation of a user.

Since the user has known first predetermined information of the video program, the second requesting module 670 desires to further know the second information of the video program according to the first predetermined information of the video program that has been known. For example, following the above embodiment, assume that the first predetermined information of the video program displayed in the above step is actor/actress information, then the second requesting module 670 of the mobile terminal may request to acquire further detailed information of the actor/actress according to the third predetermined operation. Alternatively, if the first predetermined information is other information, the user may request, from the server, other second information of the video program according to the third predetermined operation. It may be understood that the third predetermined operation may be an operation via a key, an operation via a gesture, or an operation via touching a screen, which is not limited in the embodiment of the present disclosure. The second information may be also any predetermined information. For example, details of the actor/actress may be such personal information as age, height or the like of the actor/actress, or may be awards information, resume or the like of the actor/actress, which are not limited in the embodiment of the present disclosure.

The third acquiring module 680 is configured to acquire second predetermined information of the video program.

The third acquiring module 680 of the mobile terminal acquires second predetermined information of the video program according to information returned by the server.

Specifically, the displaying module is further configured to display the second predetermined information of the video program acquired by the third acquiring module.

In the embodiment of the present disclosure, upon displaying the first predetermined information of the video program, the mobile terminal acquires and displays the second predetermined information of the video program according to the operation of the user, such that the user may get more and deeper knowledge of the video program, interactions between the user and the video program played the video device via the mobile terminal may be further deepened, and the user experience is further enhanced.

The embodiment of the present disclosure provides a non-volatile computer storage medium storing computer executable instructions, wherein the computer executable instructions may be used to perform the video program interaction method in any one of the method embodiments.

FIG. 11 is a schematic structural diagram illustrating hardware of an electronic device for performing the video program interaction method according to some embodiments of the present disclosure.

As illustrated in FIG. 11, the electronic device includes at least one processor 910 and a memory 920, and FIG. 11 uses one processor 910 as an example.

The electronic device for performing video program interaction method may further include: an input device 930 and an output device 940.

The processor 910, the memory 920, the input apparatus 930 and the output apparatus 940 may be connected to each other via a bus or in another manner FIG. 11 uses connection via a bus as an example for description.

The memory, as a non-volatile computer readable storage medium, may be configured to store non-volatile software programs, non-volatile computer executable programs and modules, for example, the program instructions/modules corresponding to the video program interaction method in the embodiments of the present disclosure (for example, the first acquiring module 620 and the second acquiring module 630 as illustrated in FIG. 6). The non-volatile software programs, instructions and modules stored in the memory 920, when being executed, cause the processor 910 to perform various function application and data processing of a server, that is, performing the video program interaction method in the above method embodiments.

The memory 920 may also include a program storage area and a data storage area. The program storage area may store an operating system and an application implementing at least one function. The data storage area may data created according to use of the electronic device for the video program interaction. In addition, the memory 920 may include a high speed random access memory, or include a non-volatile memory, for example, at least one disk storage device, a flash memory device, or another non-volatile solid storage device. In some embodiments, the memory 920 optionally includes memories remotely configured relative to the processor 910. These memories may be connected to the processing apparatus for video program interaction. The above examples include, but not limited to, the Internet, Intranet, local area network, mobile communication network and a combination thereof.

The input apparatus 930 may receive input digital or character information, and generate signal input related to user settings and function control of the electronic device for video program interaction. The output apparatus 940 may include a display screen or the like display device.

One or more modules are stored in the memory 920, and when being executed by the at least one processors 910, perform the video program interaction method in any of the above method embodiments.

The product may perform the method according to the embodiments of the present disclosure, has corresponding function modules for performing the method, and achieves the corresponding beneficial effects. For technical details that are not illustrated in detail in this embodiment, reference may be made to the description of the methods according to the embodiments of the present disclosure.

The electronic device in the embodiments of the present disclosure is practiced in various forms, including, but not limited to:

(1) a mobile communication device: which has the mobile communication function and is intended to provide mainly voice and data communications; such terminals include: a smart phone (for example, an iPhone), a multimedia mobile phone, a functional mobile phone, a low-end mobile phone and the like;

(2) an ultra mobile personal computer device: which pertains to the category of personal computers and has the computing and processing functions, and additionally has the mobile Internet access feature; such terminals include: a PDA, an MID, an UMPC device and the like, for example, an iPad;

(3) a portable entertainment device: which displays and plays multimedia content; such devices include: an audio or video player (for example, an iPod), a palm game machine, an electronic book, and a smart toy, and a portable vehicle-mounted navigation device.

(4) a server: which provides services for computers, and includes a processor, a hard disk, a memory, a system bus and the like; the server is similar to the general computer in terms of architecture; however, since more reliable services need to be provided, higher requirements are imposed on the processing capability, stability, reliability, security, extensibility, manageability and the like of the device.

(5) another electronic device having the data interaction function.

The above described apparatus embodiments are merely for illustration purpose only. The units which are described as separate components may be physically separated or may be not physically separated, and the components which are illustrated as units may be or may not be physical units, that is, the components may be located in the same position or may be distributed into a plurality of network units. A part or all of the modules may be selected according to the actual needs to achieve the objectives of the technical solutions of the embodiments.

According to the above embodiments of the present invention, a person skilled in the art may clearly understand that the embodiments of the present invention may be implemented by means of hardware or by means of software plus a necessary general hardware platform. Based on such understanding, portions of the technical solutions of the present disclosure that essentially contribute to the related art may be embodied in the form of a software product, the computer software product may be stored in a storage medium, such as a ROM/RAM, a magnetic disk, a CD-ROM and the like, including several instructions for causing a computer device (a personal computer, a server, or a network device) to perform the various embodiments of the present disclosure, or certain portions of the method of the embodiments.

Finally, it should be noted that the foregoing embodiments are merely used to illustrate the technical solutions of the present disclosure rather than limiting the technical solutions of the present disclosure. Although the present disclosure is described in detail with reference to the foregoing embodiments, persons of ordinary skill in the art should understand that they may still make modifications to the technical solutions described in the foregoing embodiments, or make equivalent replacements to some of the technical features; however, such modifications or replacements do not cause the essence of the corresponding technical solutions to depart from the spirit and scope of the technical solutions of the embodiments of the present disclosure.

What is claimed is:

1. A video program interaction method, applied to a terminal, comprising:
requesting, from a video device connected to a mobile terminal, an identifier of a video program being played by the video device;
acquiring the identifier of the video program sent by the video device;
acquiring first predetermined information of the video program according to the identifier of the video program; and
displaying the first predetermined information of the video program.

2. The method according to claim 1, further comprising:
hiding the displayed first predetermined information according to a first predetermined operation of a user.

3. The method according to claim 2, further comprising:
displaying the hidden information according to a second predetermined operation of the user.

4. The method according to claim 1, wherein the acquiring first predetermined information of the video program according to the identifier of the video program comprises:
requesting, from a server, the first predetermined information of the video program; and
acquiring, from the server, the first predetermined information of the video program.

5. The method according to claim 1, further comprising:
judging a program which is running on the mobile terminal to control the video device.

6. The method according to claim 1, further comprising:
requesting, from the server, second information of the video program according to a third predetermined operation of a user;
acquiring second predetermined information of the video program; and
displaying the second predetermined information of the video program.

7. A non-transitory computer-readable storage medium storing computer executable instructions, when executed by an electronic device, cause the electronic device to:
request, from a video device connected to a mobile terminal, an identifier of a video program being played by the video device;
acquire the identifier of the video program sent by the video device;
acquire first predetermined information of the video program according to the identifier of the video program; and
display the first predetermined information of the video program.

8. The non-transitory computer-readable storage medium storing computer executable instructions according to claim 7, wherein the electronic device is further caused to:
hide the displayed first predetermined information according to a first predetermined operation of a user.

9. The non-transitory computer-readable storage medium storing computer executable instructions according to claim 7, wherein the electronic device is further caused to:
display the hidden information according to a second predetermined operation of the user.

10. The non-transitory computer-readable storage medium according to claim 7, wherein the step to acquire first predetermined information of the video program according to the identifier of the video program comprises:
request, from a server, the first predetermined information of the video program; and
acquire, from the server, the first predetermined information of the video program.

11. The non-transitory computer-readable storage medium storing computer executable instructions according to claim 7, wherein the electronic device is further caused to:
judge a program which is running on the mobile terminal to control the video device.

12. The non-transitory computer-readable storage medium storing computer executable instructions according to claim 7, wherein the electronic device is further caused to:
request, from the server, second information of the video program according to a third predetermined operation of a user;
acquire second predetermined information of the video program; and
display the second predetermined information of the video program.

13. An electronic device, comprising:
at least one processor; and
a memory communicably connected with the at least one processor for storing instructions executable by the at least one processor, wherein execution of the instructions by the at least one processor causes the at least one processor to:
request, from a video device connected to a mobile terminal, an identifier of a video program being played by the video device;
acquire the identifier of the video program sent by the video device;
acquire first predetermined information of the video program according to the identifier of the video program; and
display the first predetermined information of the video program.

14. The electronic device according to claim 13, wherein the execution of the instructions by the at least one processor causes the at least one processor to: hide the displayed first predetermined information according to a first predetermined operation of a user.

15. The electronic device according to claim 13, wherein the execution of the instructions by the at least one processor causes the at least one processor to: display the hidden information according to a first predetermined operation of a user.

16. The electronic device according to claim 13, wherein the step to acquire first predetermined information of the video program according to the identifier of the video program comprises:
request, from a server, the first predetermined information of the video program; and
acquire, from the server the first predetermined information of the video program.

17. The electronic device according to claim 13, wherein the execution of the instructions by the at least one processor causes the at least one processor to: judge a program which is running on the mobile terminal to control the video device.

18. The electronic device according to claim 13, wherein the execution of the instructions by the at least one processor causes the at least one processor to: request, from the server, second information of the video program according to a third predetermined operation of a user;
acquire second predetermined information of the video program; and
display the second predetermined information of the video program.
